(19) United States
(12) Patent Application Publication
(10) Pub. No.: US 2024/0157972 A1
(43) Pub. Date: May 16, 2024

(54) Apparatus and Method for Controlling Vehicle

(71) Applicants: Hyundai Motor Company, Seoul (KR); Kia Corporation, Seoul (KR)

(72) Inventor: Jeong Hun Ham, Goyang-si (KR)

(21) Appl. No.: 18/330,577

(22) Filed: Jun. 7, 2023

(30) Foreign Application Priority Data
Nov. 14, 2022 (KR) 10-2022-0151662

(51) Int. Cl. B60W 60/00; B60W 40/02; B60W 50/00; G06V 20/56

(52) U.S. Cl. CPC B60W 60/0015; B60W 40/02; B60W 50/0097; G06V 20/56; B60W 2420/42; B60W 2555/20; B60W 2556/10; B60W 2556/45

(57) ABSTRACT

An embodiment apparatus for controlling a vehicle includes a communication device configured to obtain weather data in an area where the vehicle is located, a sensor configured to obtain precipitation data, an image acquisition device configured to obtain image data around the vehicle, and a controller configured to determine a possibility of flooding of the vehicle based on the weather data obtained from the communication device and the precipitation data obtained from the sensor and, in response to a determination that it is possible for the vehicle to be flooded, determine a current state of the vehicle based on the image data and predict a future flooding situation based on the weather data, the precipitation data, or the image data.

### CROSS-REFERENCE TO RELATED APPLICATIONS

This application claims the benefit of Korean Patent Application No. 10-2022-0151662, filed on Nov. 14, 2022, which application is hereby incorporated herein by reference.

### TECHNICAL FIELD

The present disclosure relates to an apparatus and a method for controlling a vehicle.

### BACKGROUND

Conventionally, a vehicle was equipped with a plurality of sensors to monitor submersion of the vehicle. In the event of flooding, a technology that controls a suspension of the vehicle to prevent the vehicle from being flooded has been suggested.

However, as torrential rains frequently occur due to climate change, water levels rise rapidly for a short time, resulting in vehicle flooding damage not only to parked vehicles but also to vehicles which are traveling. Thus, there is a need for a technology capable of determining flooding of a vehicle within a faster time and moving the vehicle.

### SUMMARY

Embodiments of the present disclosure can solve problems occurring in the prior art while advantages achieved by the prior art are maintained intact.

An embodiment of the present disclosure provides an apparatus and a method for controlling a vehicle to collect data for determining a possibility of flooding of a vehicle and to determine a possibility of flooding of the vehicle based on the collected data.

Another embodiment of the present disclosure provides an apparatus and a method for controlling a vehicle to determine a current state of a vehicle in real time based on an image obtained by the vehicle.

Another embodiment of the present disclosure provides an apparatus and a method for controlling a vehicle to predict a flooding situation based on weather data and sensing information obtained by the vehicle.

Another embodiment of the present disclosure provides an apparatus and a method for controlling a vehicle to notify a user of a current state of a vehicle and a predicted flooding situation in real time, when the vehicle is parked, such that the user recognizes the flooding situation of the vehicle even when the user does not ride in the vehicle.

Another embodiment of the present disclosure provides an apparatus and a method for controlling a vehicle to generate a travel route of a vehicle and allow the vehicle to travel and park, when it is predicted that the vehicle will be flooded in the location where the vehicle is parked.

[soon] Another embodiment of the present disclosure provides an apparatus and a method for controlling a vehicle to provide a notification of a travelable distance and generate a travel route to a parking place, when it is impossible for a vehicle to travel to a destination as it is predicted that the vehicle will be flooded in the location where the vehicle is traveling.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, an apparatus for controlling a vehicle may include a communication device that obtains weather data in an area where a vehicle is located, a sensor that obtains precipitation data, an image acquisition device that obtains image data around the vehicle, and a controller that determines a possibility of flooding of the vehicle based on the weather data obtained from the communication device and the precipitation data obtained from the sensor, determines a current state of the vehicle based on the image data, and when it is determined that it is possible for the vehicle to be flooded, predicts a future flooding situation based on at least one of the weather data, the precipitation data, the image data, or a combination thereof.

The communication device may receive the weather data and local image data in the area where the vehicle is located from a server and may receive user request data from a user terminal.

The sensor may include a rain sensor that obtains the precipitation data.

The controller may learn artificial intelligence based on at least one of the previously obtained weather data, the previously obtained precipitation data, the previously obtained image data, or a combination thereof and may determine the possibility of flooding of the vehicle based on the learned result.

The controller may determine the current state of the vehicle as a flooded state, when a second contour of the vehicle generated based on the image data is cut off or blurred compared to a first contour of the vehicle in a normal state, the first contour being generated in advance.

The controller may measure a degree of flooding at intervals of a certain time based on the image data to determine a change in flooding, after the current state of the vehicle is determined, and may predict the future flooding situation based on the change in flooding.

The controller may store a change in flooding based on at least one of the weather data, the precipitation data, the image data, or the combination thereof after the current state of the vehicle is determined and may predict the future flooding situation based on the stored information.

The controller may determine whether it is possible for the vehicle to travel to a destination based on the current state and the future flooding situation and may generate a travel route of the vehicle to a safe place to provide a notification of the travel route, when it is impossible for the vehicle to travel to the destination.

The controller may transmit the image data to a user terminal in real time, when the vehicle is parked, and may transmit a message for providing a notification of the current state of the vehicle, the future flooding situation, and a vehicle travelable time to the user terminal.

The controller may enter an emergency vehicle travel mode and may control the vehicle to travel with autonomous driving along the travel route of the vehicle to the safe place, when it is determined that it is impossible for a user to move the vehicle within the vehicle travelable time based on user feedback.

The controller may control an output device to output a message for providing a notification of the current state of the vehicle and the future flooding situation, when the vehicle is traveling.

The controller may determine whether it is possible for the vehicle to travel to the destination, when the vehicle is traveling, and may control an output device to output a distance where it is possible for the vehicle to travel from a current location of the vehicle, when it is determined that it is impossible for the vehicle to travel to the destination.

According to another embodiment of the present disclosure, a method for controlling a vehicle may include obtaining, by a communication device, weather data in an area where a vehicle is located, obtaining, by a sensor, precipitation data, determining, by a controller, a possibility of flooding of the vehicle based on the obtained data, determining, by the controller, a current state of the vehicle based on image data around the vehicle, the image data being obtained by an image acquisition device, when it is determined that it is possible for the vehicle to be flooded, and predicting, by the controller, a future flooding situation based on at least one of the weather data, the precipitation data, the image data, or a combination thereof.

The determining of the possibility of flooding of the vehicle may include learning artificial intelligence based on at least one of the previously obtained weather data, the previously obtained precipitation data, the previously obtained image data, or a combination thereof and determining the possibility of flooding of the vehicle based on the learned result.

The method may further include determining, by the controller, the current state of the vehicle as a flooded state, when a second contour of the vehicle generated based on the image data is cut off or blurred compared to a first contour of the vehicle in a normal state, the first contour being generated in advance.

The predicting of the future flooding situation may include measuring, by the controller, a degree of flooding at intervals of a certain time based on the image data to determine a change in flooding, after the current state of the vehicle is determined, and predicting, by the controller, the future flooding situation based on the change in flooding.

The method may further include determining, by the controller, whether it is possible for the vehicle to travel to a destination based on the current state and the future flooding situation and generating, by the controller, a travel route of the vehicle to a safe place to provide a notification of the travel route, when it is impossible for the vehicle to travel to the destination.

The method may further include transmitting, by the controller, the image data to a user terminal in real time, when it is determined that the vehicle is parked, and transmitting, by the controller, a message for providing a notification of the current state of the vehicle, the future flooding situation, and a vehicle travelable time to the user terminal.

The method may further include entering, by the controller, an emergency vehicle travel mode and controlling, by the controller, the vehicle to travel with autonomous driving along the travel route of the vehicle to the safe place, when it is determined that it is impossible for a user to move the vehicle within the vehicle travelable time based on user feedback.

The method may further include determining, by the controller, whether it is possible for the vehicle to travel to the destination, when it is determined that the vehicle is traveling, and controlling, by the controller, an output device to output a distance where it is possible for the vehicle to travel from a current location of the vehicle, when it is determined that it is impossible for the vehicle to travel to the destination.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a block diagram illustrating a configuration of an apparatus for controlling a vehicle according to an embodiment of the present disclosure;

FIG. 2 is a drawing schematically illustrating an image acquisition device and an output device according to an embodiment of the present disclosure;

FIGS. 3 and 4 are drawings schematically illustrating a contour of a vehicle according to an embodiment of the present disclosure;

FIGS. 5 and 6 are flowcharts illustrating a method for controlling a vehicle according to an embodiment of the present disclosure; and

FIG. 7 is a block diagram illustrating a configuration of a computing system for executing a method according to an embodiment of the present disclosure.

### DETAILED DESCRIPTION OF ILLUSTRATIVE EMBODIMENTS

Hereinafter, some embodiments of the present disclosure will be described in detail with reference to the accompanying drawings. In adding the reference numerals to the components of each drawing, it should be noted that the identical component is designated by the identical numerals even when they are displayed on other drawings. Further, in describing the embodiments of the present disclosure, a detailed description of well-known features or functions will be omitted in order not to unnecessarily obscure the gist of the present disclosure.

In describing the components of the embodiments according to the present disclosure, terms such as first, second, “A,” “B,” (a), (b), and the like may be used. These terms are merely intended to distinguish one component from another component, and the terms do not limit the nature, sequence, or order of the corresponding components. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art and are not to be interpreted as having ideal or excessively formal meanings unless clearly defined as having such in the present application.

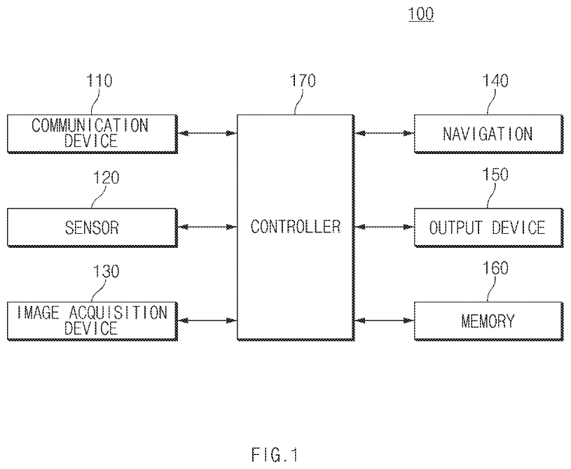

FIG. 1 is a block diagram illustrating a configuration of an apparatus for controlling a vehicle according to an embodiment of the present disclosure.

As shown in FIG. 1, an apparatus 100 for controlling a vehicle may include a communication device no, a sensor 120, an image acquisition device 130, navigation 140, an output device 150, a memory (i.e., a storage) 160, and a controller 170.

The communication device no may wirelessly communicate with a server (not shown) and a user terminal (not shown). The communication device no may obtain weather data in an area where the vehicle is located and local image data (or CCTV image data) from the server and may obtain user request data from the user terminal. Furthermore, the communication device no may receive image data around a host vehicle from another vehicle, a pedestrian, a traffic infrastructure (e.g., a CCTV), an internet of things (IoT), or the like. Hereinafter, for convenience of description, the image data received by the communication device no is referred to as “local image data.”

According to an embodiment, the communication device no may use wireless communication, for example, at least one of wireless-fidelity (Wi-Fi), wireless broadcast (WiBro), long term evolution (LTE), long term evolution-advanced (LTE-A), a fifth generation (5G) wireless system, mm-wave or 60 GHz wireless communication, a wireless universal serial bus (USB), code division multiple access (CDMA), wideband CDMA (WCDMA), a universal mobile telecommunications system (UMTS), or a global system for mobile communication (GSM).

The communication device no may include vehicle-to-vehicle (V2V) communication, vehicle-to-everything (V2X) communication, vehicle-to-infrastructure (V2I) communication, or vehicle-to-pedestrian (V2P) communication.

The sensor 120 may obtain various pieces of data of the vehicle. According to an embodiment, the sensor 120 may include a speed sensor, a battery sensor, a fuel sensor, a tire sensor, a rain sensor, a radar, a light detection and ranging (LiDAR), or the like, may obtain speed data, battery data, fuel data, tire data, precipitation data, or the like by means of it, and may sense an object (e.g., a water surface) around the vehicle.

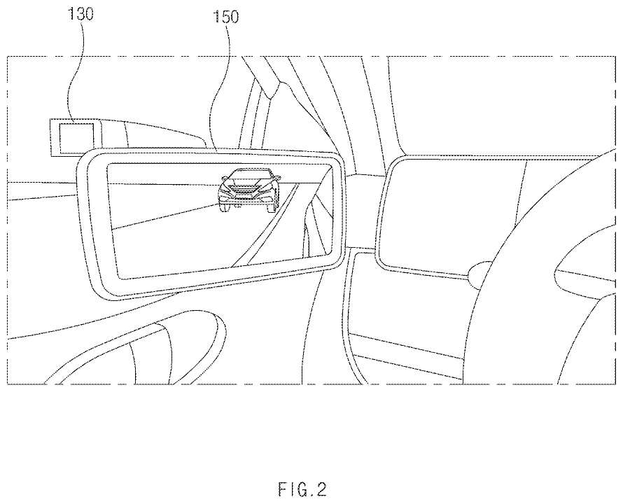

The image acquisition device 130 may be implemented with one or more cameras provided in the vehicle to obtain image data around the vehicle. According to an embodiment, the image acquisition device 130 may include at least one of a surround view camera, a digital side mirror camera, or a combination thereof. The surround view camera may include at least one of a front view camera, a left view camera, a right view camera, a rear view camera, or a combination thereof. The digital side mirror camera may obtain image data from the side and rear of the vehicle. A detailed description refers to FIG. 2.

FIG. 2 is a drawing schematically illustrating an image acquisition device and an output device according to an embodiment of the present disclosure.

As shown in FIG. 2, digital side mirror cameras may be provided at a left side and a right side of a vehicle to obtain image data from the side and rear of the vehicle. In addition, the image data obtained by means of an image acquisition device 130 may be output on an output device 150 provided in the vehicle.

Referring again to FIG. 1, the navigation 140 may include a GPS receiver to obtain location information of the vehicle, may map-match the location of the vehicle to previously stored map data to provide a map image in a certain area with respect to the location of the vehicle, and may provide a route from the current location to a destination set by a driver of the vehicle.

The output device 150 may be implemented as a display device, a sound output device, or the like. Herein, the display device may include an output device for outputting the image data obtained by the image acquisition device 130, a display of the navigation 140, a head-up display (HUD), a cluster, or the like. The output device 150 may be implemented as at least one of a liquid crystal display (LCD), a thin film transistor-LCD (TFT-LCD), an organic light-emitting diode (OLED) display, a flexible display, a three-dimensional (3D) display, or an electronic-ink (e-ink) display.

The memory 160 may store at least one algorithm which calculates or executes various commands for an operation of the apparatus for controlling the vehicle according to an embodiment of the present disclosure. The memory 160 may include at least one of a flash memory, a hard disc, a memory card, a read-only memory (ROM), a random access memory (RAM), an electrically erasable and programmable ROM (EEPROM), a programmable ROM (PROM), a magnetic memory, a magnetic disc, or an optical disc.

The controller 170 may be implemented by various processing devices, such as a microprocessor, embedding a semiconductor chip or the like capable of calculating or executing various commands, and may control an operation of the apparatus for controlling the vehicle according to an embodiment of the present disclosure. The controller 170 may be electrically connected with the communication device no, the sensor 120, the image acquisition device 130, the navigation 140, the output device 150, and the memory 160 through a wired cable or various circuits to deliver an electrical signal including a control command or the like and may transmit and receive an electrical signal including a control command or the like over a communication network including controller area network (CAN) communication.

The controller 170 may receive data for determining a possibility of flooding from a server and may obtain, collect, and store the data for determining the possibility of flooding from the sensor 120. According to an embodiment, the controller 170 may collect and store weather data received from the server and may collect and store precipitation data obtained from the sensor 120.

The controller 170 may determine a possibility of flooding based on the collected weather data and the collected precipitation data.

According to an embodiment, the controller 170 may receive weather data in an area where the vehicle is located from the server and may determine that there is a possibility that the vehicle will be flooded when it is determined that precipitation in the area where the vehicle is located is greater than a predetermined reference value (e.g., 100 mm).

According to an embodiment, the controller 170 may measure precipitation using a rain sensor and may determine that there is a possibility that the vehicle will be flooded when it is determined that the measured precipitation is greater than the predetermined reference value (e.g., 100 mm).

When it is determined that there is the possibility that the vehicle will be flooded, the controller 170 may wake up the image acquisition device 130 and may request the image acquisition device 130 to obtain image data. In addition, the controller 170 may receive local image data through the communication device no.

Furthermore, the controller 170 may obtain user request data from a user terminal and may wake up the image acquisition device 130 to determine a possibility of flooding when it is determined that the user requests to identify whether there is the possibility of flooding based on the user request data and may request the image acquisition device 130 to obtain image data. In addition, the controller 170 may receive local image data through the communication device no.

Furthermore, the controller 170 may learn artificial intelligence based on at least one of the previously obtained weather data, the previously obtained precipitation data, the previously obtained image data, the previously obtained local image data, or a combination thereof and may determine a possibility of flooding of the vehicle based on the learned result.

According to an embodiment, the controller 170 may collect and store weather data in an area where the vehicle is frequently located, may collect and store precipitation data measured by the sensor 120 in the area where the vehicle is frequently located, may collect and store image data obtained by the image acquisition device 130, may collect and store local image data received by the communication device no, and may learn artificial intelligence based on the stored data. The controller 170 may determine a possibility of flooding of the vehicle based on the learned result.

In addition, the controller 170 may adjust a predetermined reference value to determine the possibility of flooding based on the learned result and may determine the possibility of flooding.

As an example, although it is determined that the precipitation is greater than the predetermined reference value based on weather data in area A where the vehicle is located, when the precipitation measured by the vehicle is less than the reference value or when it is determined that the vehicle is not flooded based on at least one of image data, local image data, or a combination thereof, the controller 170 may upwardly adjust the predetermined reference value and may determine a possibility of flooding based on the adjusted reference value.

As another example, the controller 170 may adjust the predetermined reference value based on at least one of weather data, precipitation data, image data, local image data, or a combination thereof, which is obtained from an area most affected by flooding among places where the vehicle was located. For example, although it is determined that the precipitation is less than or equal to the predetermined reference value based on the weather data in area A where the vehicle is located, when the place where the vehicle is located is a place most affected by flooding, the controller 170 may downwardly adjust the predetermined reference value based on at least one of weather data, precipitation data, image data, local image data, or a combination thereof, which is obtained at the place where the vehicle is located, and may determine a possibility of flooding based on the adjusted reference value.

When it is determined that there is the possibility that the vehicle will be flooded, the controller 170 may determine whether the vehicle is currently parked or traveling. Hereinafter, when the vehicle is parked, the control operation of the controller 170 will first be described.

When it is determined that the vehicle is parked, the controller 170 may transmit image data obtained after the image acquisition device 130 is woken up to the user terminal in real time. In addition, the controller 170 may transmit local image data received by the communication device no to the user terminal in real time.

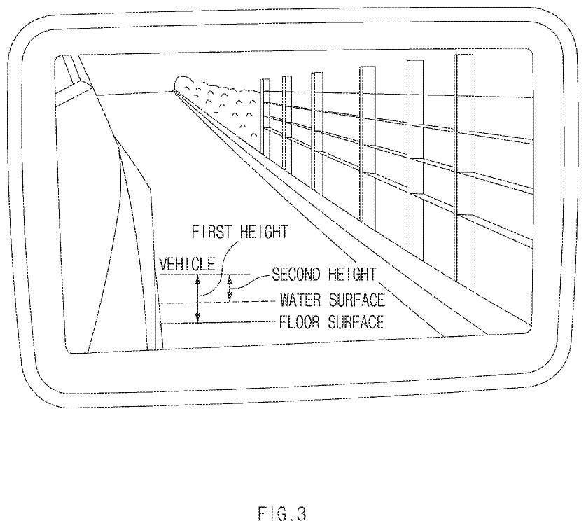

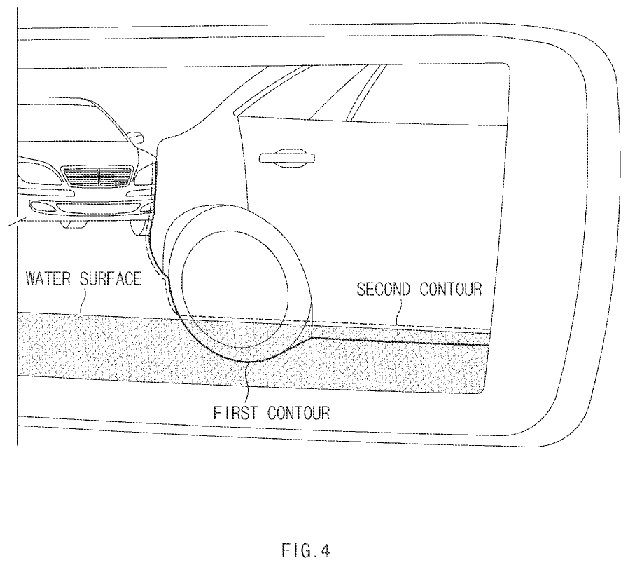

The controller 170 may determine a current state of the vehicle based on the collected data. A detailed description refers to FIG. 3 and FIG. 4.

FIGS. 3 and 4 are drawings schematically illustrating a contour of a vehicle according to an embodiment of the present disclosure.

As shown in FIG. 3, according to an embodiment, the controller 170 of FIG. 1 may previously store a first height from a floor surface of the road in a normal state (or a non-rainy state) to a vehicle, may calculate a second height from a water surface to the vehicle in case of rain, and may determine a current state of the vehicle as a flooded state, when there is a difference between the first height and the second height.

As shown in FIG. 4, according to an embodiment, the controller 170 may generate a first contour of the vehicle in a normal state (or a non-rainy state) and may generate a second contour of the vehicle based on at least one of image data obtained by the image acquisition device 130 of FIG. 1 and local image data received from a server. When the second contour is cut off or blurred compared to the first contour, the controller 170 may determine the current state of the vehicle as a flooded state.

According to an embodiment, after transmitting the at least one of the image data, the local image data, or the combination thereof to the user terminal in real time, the controller 170 may receive user request data from the user terminal to identify user feedback on the transmitted at least one of the image data, the local image data, or the combination thereof and may stop the operation when the user determines that the vehicle is not flooded and requests to cancel the operation of the controller 170.

When the current state of the vehicle is determined and when separate user request data is not received, the controller 170 may predict a future flooding situation based on at least one of weather data, precipitation data, image data, local image data, or a combination thereof.

According to an embodiment, the controller 170 may predict a future flooding situation in an area where the vehicle is located after the time point when the current state of the vehicle is determined based on the at least one of the weather data, the precipitation data, or the combination thereof.

According to an embodiment, the controller 170 may measure a degree of flooding at intervals of a certain time (e.g., 5 minutes) after the time point when the current state of the vehicle is determined based on the at least one of the image data, the local image data, or the combination thereof to determine a change in flooding and may predict a future flooding situation based on the change in flooding.

According to an embodiment, the controller 170 may predict a future flooding situation based on information stored based on at least one of weather data, precipitation data, image data, local image data, a change in flooding, or a combination thereof after the current state is determined. The controller 170 may generate the stored information as big data, may learn artificial intelligence based on the big data, and may predict a future flooding situation based on the learned information.

As an example, after the current state is determined, when the precipitation measured by the sensor 120 increases compared to the precipitation stored based on the weather data, the controller 170 may predict that the precipitation in the area where the vehicle is located will be greater than the precipitation based on the weather data.

As another example, after the current state is determined, the controller 170 may compare an amount of increase in precipitation stored during a predetermined time based on the weather data with a change in flooding stored during the predetermined time, which is obtained based on at least one of image data, local image data, or a combination thereof, and may predict a future flooding situation based on a relationship between the amount of increase in precipitation and the change in flooding when it is determined that the change in flooding does not occur in response to the amount of increase in precipitation.

The controller 170 may calculate a vehicle travelable time based on the current state and the predicted flooding situation.

As described above, when the current state of the vehicle is determined and when the future flooding situation is predicted, the controller 170 may transmit the current state and the predicted flooding situation to the user terminal and may transmit a message for providing a notification of the vehicle travelable time calculated based on the current state and the predicted flooding situation to the user terminal.

For example, the controller 170 may transmit the message for providing the notification of the current state, “It is flooded by X cm compared to the current floor surface.”, may transmit the message for providing the notification of the predicted flooding situation, “The degree of flooding is expected to increase/decrease in the future.”, and may transmit the message for providing the notification of the vehicle travelable time, “If the degree of flooding of the vehicle is over 15%, the travel of the vehicle is restricted. Move the vehicle to a safe place within 30 minutes.”

As a result, the controller 170 may allow the user to know whether the vehicle is safe from flooding and how many minutes the parked vehicle needs to travel even in a state where the user does not ride in the vehicle.

After transmitting the message to the user terminal, the controller 170 may receive user feedback corresponding to the transmitted message and may determine whether it is impossible for the user to move the vehicle within the vehicle travelable time.

When it is determined that it is impossible for the user to move the vehicle, the controller 170 may enter an emergency vehicle travel mode and may control the vehicle to travel. Herein, the emergency vehicle travel mode may refer to a mode which controls starting and autonomous driving of the vehicle.

According to an embodiment, when entering the emergency vehicle travel mode, the controller 170 may generate a travel route for moving to a place (e.g., a high land) previously stored by the user and may control the vehicle to perform autonomous driving along the travel route.

According to an embodiment, the controller 170 may determine a high land based on at least one of image data, local image data, or a combination thereof, may generate a travel route for moving to the high land, and may control the vehicle to perform autonomous driving along the travel route.

According to an embodiment, the controller 170 may receive information about a high land from the user terminal or the server, may generate a travel route for moving to the received place, and may control the vehicle to perform autonomous driving along the travel route.

Hereinafter, when the vehicle is currently traveling, the control operation of the controller 170 will be described.

When the vehicle is traveling and when there is a user request data determined based on at least one of image data, local image data, or a combination thereof by the image acquisition device 130 because it is determined that there is a probability of flooding (or there is data requested to release the operation of the controller 170 by the user because it is determined that the vehicle is not flooded), the controller 170 may stop the operation.

When there is no separate user request data, the controller 170 may determine a current state of the vehicle based on at least one of image data, local image data, or a combination thereof.

According to an embodiment, the controller 170 may determine a degree of flooding of the vehicle based on at least one of image data, local image data, or a combination thereof (refer to FIGS. 3 and 4) and may output a guidance message for providing a notification of the degree of flooding.

For example, the controller 170 may output the guidance message, “The vehicle is currently flooded by Y %. Driving may be restricted if the vehicle is flooded in excess of Z %.” on a cluster including the output device 150.

The controller 170 may determine a future flooding situation based on at least one of weather data, precipitation data, image data, local image data, or a combination thereof. The operation where the controller 170 predicts the future flooding situation in the state where the vehicle is traveling is the same as an operation where the controller 170 predicts a future flooding situation in the state where the vehicle is parked, and the description of the operation of predicting the future flooding situation in the state where the vehicle is traveling refers to the description of the operation of predicting the future flooding situation in the state where the vehicle is parked.

When the current state of the vehicle is determined and when the future flooding situation is predicted, the controller 170 may determine whether it is possible for the vehicle to travel to a destination based on the current state and the predicted flooding situation.

The controller 170 may output a message for providing a notification of the current state, the predicted flooding situation, and whether it is possible for the vehicle to travel to the destination on the output device iso.

When it is determined that it is possible for the vehicle to travel to the destination, the controller 170 may generate a travel route to the destination and may output the travel route on the output device iso. However, when it is determined that it is impossible for the vehicle to travel to the destination, the controller 170 may output a non-travelable guidance message on the output device 150 and may output a guidance message for guiding the vehicle to park on the output device 150.

The controller 170 may determine a travelable distance based on the travelable time and may output a guidance message for providing a notification of the travelable distance on the output device 150.

According to an embodiment, the controller 170 may output the guidance message, “Due to the current increase in precipitation, the vehicle must be stopped in a safe zone within 15 minutes or 1 km from the current location.”

The controller 170 may navigate a parking place within the travelable distance, may generate a travel route to the parking place, and may output a message for providing a notification of the travel route on the output device iso.

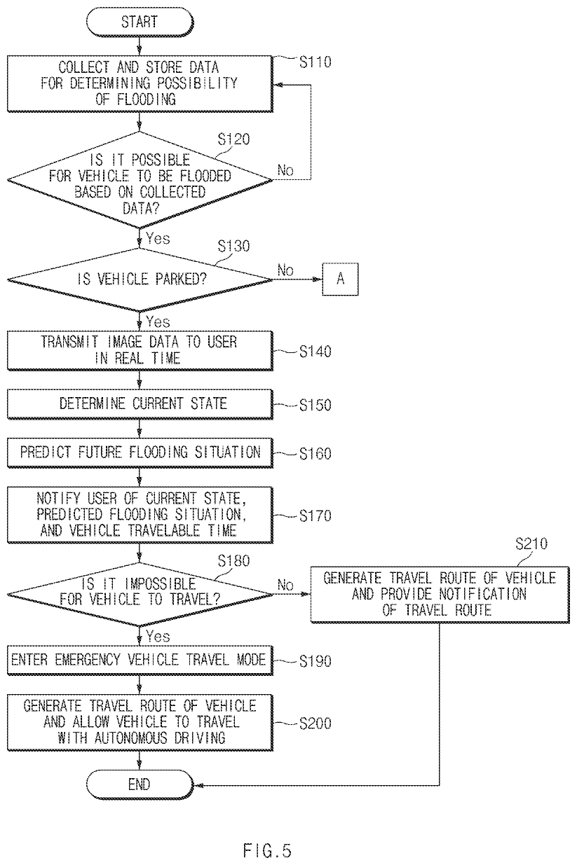

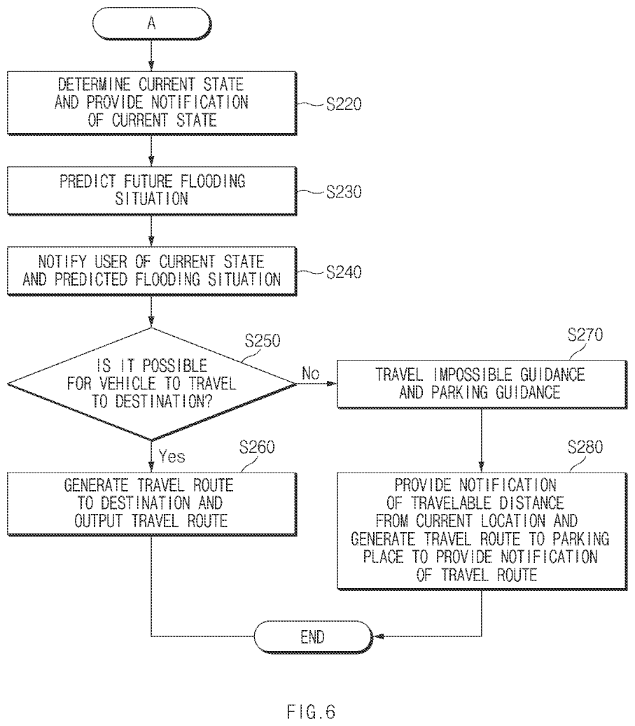

FIGS. 5 and 6 are flowcharts illustrating a method for controlling a vehicle according to an embodiment of the present disclosure.

As shown in FIG. 5, in S110, the controller 170 of FIG. 1 may receive data for determining a possibility of flooding from a server and may obtain, collect, and store the data for determining the possibility of flooding from the sensor 120 of FIG. 1.

According to an embodiment, in S110, the controller 170 may collect and store weather data received from the server and may collect and store precipitation data obtained from the sensor 120.

In S120, the controller 170 may determine whether there is a possibility that a vehicle will be flooded based on the collected weather data and the collected precipitation data.

According to an embodiment, in S120, the controller 170 may receive weather data in an area where a vehicle is located and may determine that there is the possibility that the vehicle will be flooded when it is determined that precipitation in the area where the vehicle is located is greater than a predetermined reference value (e.g., 100 mm).

According to an embodiment, in S120, the controller 170 may measure precipitation using a rain sensor and may determine that there is the possibility that the vehicle will be flooded when it is determined that the measured precipitation is greater than the predetermined reference value (e.g., boo mm).

According to an embodiment, in S120, the controller 170 may learn artificial intelligence based on at least one of the previously obtained weather data, the previously obtained precipitation data, the previously obtained image data, the previously obtained local image data, or a combination thereof and may determine a possibility of flooding of the vehicle based on the learned result.

When it is determined that there is the possibility that the vehicle will be flooded in S120, in S130, the controller 170 may determine whether the vehicle is currently parked.

According to an embodiment, when it is determined that there is the possibility that the vehicle will be flooded in S120, the controller 170 may wake up an image acquisition device 130 of FIG. 1 and may request the image acquisition device 130 to obtain image data. In addition, the controller 170 may receive local image data by means of the communication device 110 of FIG. 1.

When it is determined that the vehicle is parked in S130, in S140, the controller 170 may transmit at least one of image data, local image data, or a combination thereof to a user terminal in real time.

When it is determined that the vehicle is not parked in S130, the controller 170 may proceed to A.

In S150, the controller 170 may determine a current state of the vehicle based on the collected data. A more detailed description of S150 refers to FIGS. 3 and 4.

In S160, the controller 170 may determine a future flooding situation based on at least one of weather data, precipitation data, image data, local image data, or a combination thereof.

According to an embodiment, in S160, the controller 170 may predict a future flooding situation in an area where the vehicle is located after the time point when the current state of the vehicle is determined based on the at least one of the weather data, the precipitation data, or the combination thereof.

According to an embodiment, in S160, the controller 170 may measure a degree of flooding at intervals of a certain time (e.g., 5 minutes) after the time point when the current state of the vehicle is determined based on the at least one of the image data, the local image data, or the combination thereof to determine a change in flooding and may predict a future flooding situation based on the change in flooding.

According to an embodiment, in S160, the controller 170 may predict a future flooding situation based on information stored based on at least one of weather data, precipitation data, image data, local image data, a change in flooding, or a combination thereof after the current state is determined. The controller 170 may generate the stored information as big data, may learn artificial intelligence based on the big data, and may predict a future flooding situation based on the learned information.

As described above, when the current state of the vehicle is determined and when the future flooding situation is predicted, in S170, the controller 170 may transmit a message for providing a notification of the current state, the predicted flooding situation, and the vehicle travelable time to the user terminal.

After transmitting the message to the user terminal, in S180, the controller 170 may receive user feedback corresponding to the transmitted message and may determine whether it is impossible for the user to move the vehicle within the vehicle travelable time.

When it is determined that it is impossible for the user to move the vehicle in S180, in S190, the controller 170 may enter an emergency vehicle travel mode. The emergency vehicle travel mode in S190 may refer to a mode which controls starting and autonomous driving of the vehicle.

When entering the emergency vehicle travel mode, the controller 170 may generate a travel route for moving to a place (e.g., a high land) previously stored by the user and may control the vehicle to perform autonomous driving along the travel route.

According to an embodiment, in S200, the controller 170 may determine a high land based on at least one of image data, local image data, or a combination thereof, may generate a travel route for moving to the high land, and may control the vehicle to perform autonomous driving along the travel route.

According to an embodiment, in S200, the controller 170 may receive information about a high land from the user terminal or the server, may generate a travel route for moving to the received place, and may control the vehicle to perform autonomous driving along the travel route.

When it is determined that it is possible for the user to move the vehicle in S180, in S210, the controller 170 may generate a travel route of the vehicle and may transmit a guidance message for providing a notification of the travel route.

As shown in FIG. 6, when it is determined that the vehicle is not parked, the controller 170 may determine that the vehicle is traveling.

When the vehicle is traveling, in S220, the controller 170 may determine a current state of the vehicle based on at least one of image data, local image data, or a combination thereof and may output a message for providing a notification of the current state of the vehicle.

According to an embodiment, in S220, the controller 170 may determine a degree of flooding of the vehicle based on the at least one of the image data, the local image data, or the combination thereof (refer to FIGS. 3 and 4) and may output a guidance message for providing a notification of the degree of flooding.

In S230, the controller 170 may determine a future flooding situation based on at least one of weather data, precipitation data, image data, local image data, or a combination thereof. Because the operation of the controller 170 in S230 is similar to S160 of FIG. 5, it refers to the description of the operation in S160.

When the current state of the vehicle is determined and when the future flooding situation is predicted, in S240, the controller 170 may transmit a message for notifying the user of the current state and the predicted flooding situation to the user terminal through the output device iso.

In S250, the controller 170 may determine whether it is possible for the vehicle to travel to a destination.

When it is determined that it is possible for the vehicle to travel to the destination in S250, in S260, the controller 170 may generate a travel route to the destination and may output the travel route on the output device iso.

Meanwhile, when it is determined that it is impossible for the vehicle to travel to the destination in S250, in S270, the controller 170 may output a non-travelable guidance message on the output device iso. In S280, the controller 170 may output a guidance message for guiding the vehicle to park on the output device iso.

In S280, the controller 170 may determine a travelable distance based on the travelable time and may output a guidance message for providing a notification of the travelable distance on the output device 150. According to an embodiment, the controller 170 may output the guidance message, “Due to the current increase in precipitation, the vehicle must be stopped in a safe zone within 15 minutes or 1 km from the current location.”

In S280, the controller 170 may navigate a parking place within the travelable distance, may generate a travel route to the parking place, and may output a message for providing a notification of the travel route on the output device 150.

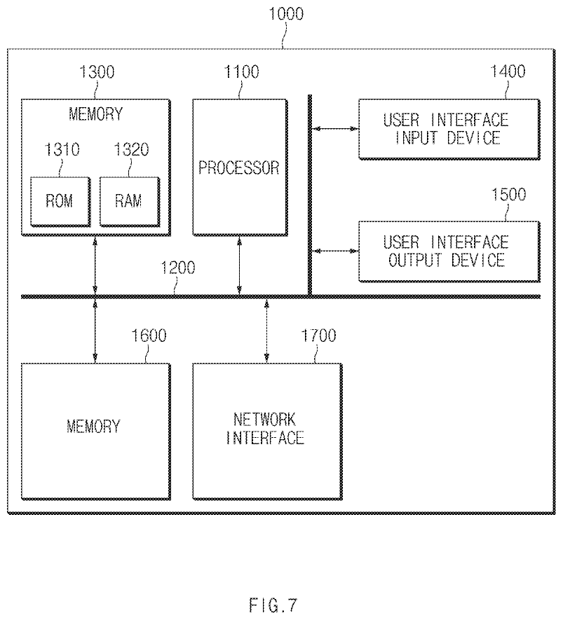

FIG. 7 is a block diagram illustrating a configuration of a computing system for executing a method according to an embodiment of the present disclosure.

Referring to FIG. 7, a computing system woo may include at least one processor 1100, a memory 1300, a user interface input device 1400, a user interface output device 1500, a memory (i.e., a storage) 1600, and a network interface 1700, which are connected with each other via a bus 1200.

The processor 1100 may be a central processing unit (CPU) or a semiconductor device that processes instructions stored in the memory 1300 and/or the memory 1600. The memory 1300 and the memory 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100 or in a combination thereof. The software module may reside on a storage medium (that is, the memory 1300 and/or the memory 1600) such as a RAM, a flash memory, a ROM, an EPROM, an EEPROM, a register, a hard disc, a removable disk, and a CD-ROM. The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The apparatus and the method for controlling the vehicle according to an embodiment of the present disclosure may determine a current state of a vehicle in real time, when the possibility of flooding of the vehicle is determined and when the vehicle is parked, may predict a flooding situation of the vehicle to notify the user of the flooding situation, and may control the vehicle to travel and park, thus providing convenience to the user who does not ride in the vehicle.

Furthermore, the apparatus and the method for controlling the vehicle according to an embodiment of the present disclosure may determine a current state of the vehicle in real time, when the possibility of flooding of the vehicle is determined and when the vehicle is traveling, may predict a flooding situation of the vehicle to notify the user of the flooding situation, and may generate a travel route to a parking place to guide the user along the travel route when it is impossible for the vehicle to travel to a destination, thus easily preventing the vehicle from being flooded.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An apparatus for controlling a vehicle, the apparatus comprising:
a communication device;
a sensor;
an image acquisition device; and
a controller configured to:
determine a possibility of flooding of the vehicle based on weather data obtained from the communication device and precipitation data obtained from the sensor, the weather data related to weather in an area of the vehicle; and
in response to a determination that it is possible for the vehicle to be flooded, determine a current state of the vehicle based on image data obtained from the image acquisition device and predict a future flooding situation based on the weather data, the precipitation data, or the image data.

2. The apparatus of claim 1, wherein the communication device is configured to receive the weather data and local image data in the area where the vehicle is located from a server and receive user request data from a user terminal.

3. The apparatus of claim 2, wherein after the current state of the vehicle is determined, the controller is configured to measure a degree of flooding at intervals of a certain time based on the image data to determine a change in flooding and to predict the future flooding situation based on the change in flooding.

4. The apparatus of claim 1, wherein the sensor comprises a rain sensor.

5. The apparatus of claim 1, wherein the controller is configured to utilize artificial intelligence based on previously obtained weather data, previously obtained precipitation data, or previously obtained image data and determine the possibility of flooding of the vehicle based on a result of the artificial intelligence.

6. The apparatus of claim 1, wherein the controller is configured to determine the current state of the vehicle as a flooded state in response to a second contour of the vehicle being cut off or blurred compared to a first contour of the vehicle in a normal state, the first contour being generated in advance and the second contour being generated based on the image data.

7. The apparatus of claim 1, wherein after the current state of the vehicle is determined, the controller is configured to store a change in flooding based on the weather data, the precipitation data, or the image data and to predict the future flooding situation based on the stored change in the flooding.

8. The apparatus of claim 1, wherein the controller is configured to:
determine that it is not possible for the vehicle to travel to an original destination based on the current state and the future flooding situation; and
in response to the determination that it is not possible for the vehicle to travel to the original destination, generate a travel route of the vehicle to a safe place to provide a notification of the travel route.

9. The apparatus of claim 1, wherein, in a case in which the vehicle is parked, the controller is configured to transmit the image data to a user terminal in real time and transmit a message for providing a notification of the current state of the vehicle, the future flooding situation, and a vehicle travelable time to the user terminal.

10. The apparatus of claim 9, wherein, in response to a determination that it is not possible for a user to move the vehicle within the vehicle travelable time based on user feedback, the controller is configured to enter an emergency vehicle travel mode and control the vehicle to autonomously travel along a travel route of the vehicle to a safe place.

11. The apparatus of claim 1, wherein, in a state in which the vehicle is traveling, the controller is configured to control an output device to output a message providing a notification of the current state of the vehicle and the future flooding situation.

12. The apparatus of claim 1, wherein, in a state in which the vehicle is traveling, the controller is configured to:
determine whether or not it is possible for the vehicle to travel to an original destination; and
in response to a determination that it is not possible for the vehicle to travel to the destination, control an output device to output a distance where it is possible for the vehicle to travel from a current location of the vehicle.

13. A method for controlling a vehicle, the method comprising:
wirelessly receiving weather data related to an area where a vehicle is located;
sensing precipitation data using a sensor of the vehicle;
determining a possibility of flooding of the vehicle based on the received weather data and the sensed precipitation data;
in response to a determination that it is possible for the vehicle to be flooded, determining a current state of the vehicle based on image data around the vehicle, wherein the image data is obtained by an image acquisition device of the vehicle; and
predicting a future flooding situation based on the weather data, the precipitation data, or the image data.

14. The method of claim 13, wherein determining the possibility of flooding of the vehicle comprises:
utilizing artificial intelligence learning based on previously obtained weather data, previously obtained precipitation data, or previously obtained image data; and
determining the possibility of flooding of the vehicle based on a result of the learning.

15. The method of claim 13, further comprising determining, the current state of the vehicle as a flooded state in response to a second contour of the vehicle being cut off or blurred compared to a first contour of the vehicle in a normal state, the first contour being generated in advance and the second contour being generated based on the image data.

16. The method of claim 15, wherein predicting the future flooding situation comprises:
after the current state of the vehicle is determined, measuring a degree of flooding at intervals of a certain time based on the image data to determine a change in flooding; and
predicting the future flooding situation based on the change in flooding.

17. The method of claim 13, further comprising:
determining whether it is possible for the vehicle to travel to a destination based on the current state and the future flooding situation; and
in response to a determination that it is not possible for the vehicle to travel to the destination, generating a travel route of the vehicle to a safe place.

18. The method of claim 13, further comprising:
in response to a determination that the vehicle is parked, transmitting the image data to a user terminal in real time; and
transmitting a message for providing a notification of the current state of the vehicle, the future flooding situation, and a vehicle travelable time to the user terminal.

19. The method of claim 18, further comprising:
in response to a determination that it is not possible for a user to move the vehicle within the vehicle travelable time based on user feedback, entering an emergency vehicle travel mode; and
controlling, the vehicle to autonomously travel along a travel route of the vehicle to a safe place.

20. The method of claim 13, further comprising:
in response to a determination that the vehicle is traveling, determining whether it is possible for the vehicle to travel to a destination, and
in response to a determination that it is not possible for the vehicle to travel to the destination, outputting a distance where it is possible for the vehicle to travel from a current location of the vehicle.
